(19) United States
(12) Patent Application Publication
(10) Pub. No.: US 2012/0182406 A1
(43) Pub. Date: Jul. 19, 2012

(54) Multi View and Stereoscopic Image Display

(75) Inventor: Jonghoon WOO, Gyeonggi-do (KR)

(73) Assignee: LG Display Co., Ltd.

(21) Appl. No.: 13/309,791

(22) Filed: Dec. 2, 2011

(30) Foreign Application Priority Data
Dec. 17, 2010 (KR) 10-2010-0130068

(51) Int. Cl. H04N 13/04; G02B 27/26; G02B 27/22

(52) U.S. Cl. 348/54; 359/464; 359/465; 348/E13.026

(57) ABSTRACT

A multi view and stereoscopic image display comprises: first glasses that comprise a first left-eye filter and a first right-eye filter, allow only a first image to pass through the first left-eye filter and the first right-eye filter in a multi view mode, and allow a left-eye image and a right-eye image to respectively pass through the first left-eye filter and the first right-eye filter in a 3D mode; and second glasses that comprise a second left-eye filter and a second right-eye filter, allow only a second image to pass through the second left-eye filter and the second right-eye filter in the multi view mode, and allow the left-eye image and the right-eye image to respectively pass through the second left-eye filter and the second right-eye filter in the 3D mode.

This application claims the benefit of Korea Paten Application No. 10-2010-0130068 field on Dec. 17, 2010, the entire contents of which is incorporated herein by reference for all purposes as if fully set forth herein.

### BACKGROUND

1. Field

This document relates to a multi view and stereoscopic image display, which allows each viewer to view a different image and selectively displays the image as a stereoscopic image.

2. Related Art

With the recent increase of interest in information display devices, flat panel displays (FPDs) have been studied and commercialized as a means to replace existing display devices such as cathode ray tubes (CRTs). Examples of flat panel displays include liquid crystal displays (LCDs), field emission displays (FEDs), plasma display panels (PDPs), and electroluminescence devices (ELs).

Because liquid crystal displays (LCDs) are advantageous in being thin and lightweight and have excellent image quality, they are actively used in laptop computers, monitors for desktop computer, and the like, and widely used as display devices of portable information equipment for reproducing multimedia content. Moreover, a liquid crystal display device is widely used as a display device of a navigation system that is combined with a global positioning system and for displaying a movie or TV program.

As shown in FIG. 1, a portable information equipment or navigation system needs to allow viewers positioned at different angles from a display device DIS to view different images from each other. For example, the navigation system demands a display device which is capable of allowing a driver to view a map image and allowing an assistant driver to view a movie or TV program. To cope with this demand, liquid crystal display devices are developed as multi view displays according to their application products.

In a multi view display, as shown in FIG. 2, a barrier 4 is installed between a display panel 2 and viewers, and the barrier 4 is used to separate the pixels viewed by the viewer A and the pixels viewed by the viewer B. A parallax barrier type is generally used as the barrier 4. When the display panel 2 displays a first image on the pixels viewed by the viewer A and a second image on the pixels viewed by the viewer B, the viewer A and the viewer B can see images of different content.

The multi view display as shown in FIG. 2 can adequately represent a multi view angle by properly aligning the pixels of the display panel 2 and the barrier according to design values. When the pixels of the display panel 2 and the barrier 4 are aligned according to the design values, the barrier 4 can transmit and block light at view angles of the viewers. In FIG. 2, P denotes the pixel pitch of the display panel; S denotes the viewing distance between the pixels of the display panel 2 and the barrier 4; D denotes the distance between a viewer and the barrier 4; and E denotes the distance between the viewers. The distance D between the barrier 4 and a viewer is determined by D=SE/P.

FIG. 3 is a view showing a cross-sectional structure of a liquid crystal display LCD implemented as a multi view display. The liquid crystal display LCD includes a thin film transistor (hereinafter, “TFT”) array substrate 6, a color filter array substrate 8 facing the TFT array substrate, and a liquid crystal layer 10 formed between the TFT array substrate 6 and the color filter array substrate 8, a barrier substrate 14 disposed on the color filter array substrate 8, and a bonding layer 12 for bonding the color filter array substrate 8 and the barrier substrate 14. The TFT array substrate includes data lines and gate lines crossing each other, TFTs formed at crossings of the data lines and the gate lines, pixel electrodes defined in a matrix form by the data lines and the gate lines, and a storage capacitor for maintaining the voltage of the liquid crystal cells. The color filter array substrate includes a black matrix, color filters, and a common electrode. Polarizing plates are attached respectively to the color filter array substrate and the TFT array substrate, and an alignment film for setting a pre-tilt angle of liquid crystal is formed thereon. Spacers for maintaining a cell gap of the liquid crystal layer are formed between the color filter array substrate and the TFT array substrate.

The multi view display as shown in FIG. 2 has inevitably low aperture ratio and luminance due to the barrier 4. The multi view display as shown in FIG. 2 has the following problems in the manufacturing process. The manufacturing process of a multi view display using a barrier generally includes a glass sliming process for reducing the glass substrate thickness of the color filter array substrate 8 of the display panel and a process of aligning and binding the color filter array substrate 8 and the barrier substrate 14 because the distance between the barrier 4 and the pixels is short. Because the glass substrate thickness of the color filter array substrate 8 should be etched except several tens of μ. The glass slimming process has the problems such as damage to the glass substrate in handling or feeding the substrate in the manufacturing process or loss of a pad portion for connecting the data lines and the gate lines to a drive IC in an etching process to obtain a small-to-medium size multi view display. The bonding process of the color filter array substrate 8 and the barrier substrate 14 has the problems of misalignment and damage to the substrate caused by bonding pressure.

The multi view display as shown in FIG. 2 is not compatible with a stereoscopic image display. The reason of which can be explained by factors to be considered in design. In general, the multi view display is designed according to almost the same principle as the principle of realization of a stereoscopic image using binocular parallax. The expression to be primarily taken into account for the multi view display is D=SE/P. Here, the viewing distance D is not so different in both of the multi view display and the stereoscopic image display, and the pixel pitch P is a fixed factor for a display panel. Although E for the multi view display is a distance between viewers, E for the stereoscopic image display is a distance between both eyes (left and right eyes) of a viewer, which shows a big difference between the two. The distance between the two eyes of the viewer is approximately 65 mm; whereas the distance between the viewers of the multi view display is approximately 650 mm. Accordingly, there is a difference of approximately 10 times between the multi view display and the stereoscopic image display. To overcome the difference in E between the two devices, the spacing S between the pixels of the display panel 2 and the barrier 4 has to be 1/10. However, the distance between the pixels and the barrier 4 is an invariable fixed value. As a result, the structure as shown in FIG. 2 is not changeable between the multi view display and the stereoscopic image display, and can be implemented in either one of the multi view display and the stereoscopic image display by setting the design factors to multi view or stereoscopic image.

### SUMMARY

An aspect of this document is to provide a touch screen panel, which prevents first and second jumping bridges and first and second routing wiring lines from becoming visible at the interface between an electrode forming area and a routing wiring line area, and prevents damage of contact holes caused by static electricity.

There is provided a multi view and stereoscopic image display according to the present invention, the multi view and stereoscopic image display: a display panel that displays a first image for a first viewer and a second image for a second viewer in multi view mode and displays images of the left-eye and right-eye in 3D mode; first glasses that comprise a first left-eye filter and a first right-eye filter, allow only the first image to pass through the first left-eye filter and the first right-eye filter in the multi view mode, and allow the left-eye image and the right-eye image to respectively pass through the first left-eye filter and the first right-eye filter in the 3D mode; and second glasses that comprise a second left-eye filter and a second right-eye filter, allow only the second image to pass through the second left-eye filter and the second right-eye filter in the multi view mode, and allow the left-eye image and the right-eye image to respectively pass through the second left-eye filter and the second right-eye filter in the 3D mode.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a view schematically showing a multi view display;

FIG. 2 is a view schematically showing a multi view display using a barrier;

FIG. 3 is a view showing a cross-sectional structure of a liquid crystal display implemented as a multi view display;

FIG. 4 is a block diagram showing a multi view and stereoscopic image display according to a first exemplary embodiment of the present invention;

FIG. 5 is a view illustrating a multi view mode operation in the multi view stereoscopic image display according to the first exemplary embodiment of the present invention;

FIG. 6 is a view illustrating a 3D mode operation in the multi view and stereoscopic image display according to the first exemplary embodiment of the present invention;

FIG. 7 is a block diagram showing a multi view and stereoscopic image display according to a second exemplary embodiment of the present invention;

FIG. 8 is a view illustrating a multi view mode operation in the multi view stereoscopic image display according to the second exemplary embodiment of the present invention;

FIG. 9 is a view illustrating a 3D mode operation in the multi view and stereoscopic image display according to the second exemplary embodiment of the present invention;

FIG. 10 is a view showing the polarization properties of each of the optical parts of the display panel and active polarization glasses in FIG. 8;

FIG. 11a is a view showing the polarization properties of each of the optical parts of the display panel and active polarization glasses viewed from the left-eye and right-eye of viewer A in FIG. 10.

FIG. 11b is a view showing the polarization properties of each of the optical parts of the display panel and active polarization glasses viewed from the left-eye and right-eye of viewer B in FIG. 10.

FIG. 12 is a view showing the polarization properties of each of the optical parts of the display panel and active polarization glasses in FIG. 9;

FIG. 13 is a view showing the polarization properties of each of the optical parts of the display panel and active polarization glasses viewed from the left-eyes and right-eyes of viewers in FIG. 12.

FIG. 14 is a block diagram showing a multi view and stereoscopic image display according to a third exemplary embodiment of the present invention;

FIG. 15 is a view illustrating a multi view mode operation in the multi view stereoscopic image display according to the third exemplary embodiment of the present invention;

FIG. 16 is a view showing the polarization properties of each of the optical parts of the display panel and active polarization glasses in FIG. 15;

FIG. 17a is a view showing the polarization properties of each of the optical parts of the display panel and active polarization glasses viewed from the left-eye and right-eye of viewer A in FIG. 16.

FIG. 17b is a view showing the polarization properties of each of the optical parts of the display panel and active polarization glasses viewed from the left-eye and right-eye of viewer B in FIG. 16.

FIG. 18 is a view illustrating a 3D mode operation in the multi view and stereoscopic image display according to the second exemplary embodiment of the present invention;

FIG. 19 is a view showing the polarization properties of each of the optical parts of the display panel and active polarization glasses in FIG. 18;

FIG. 20 is a view showing the polarization properties of each of the optical parts of the display panel and active polarization glasses viewed from the left-eyes and right-eyes of viewers in FIG. 19.

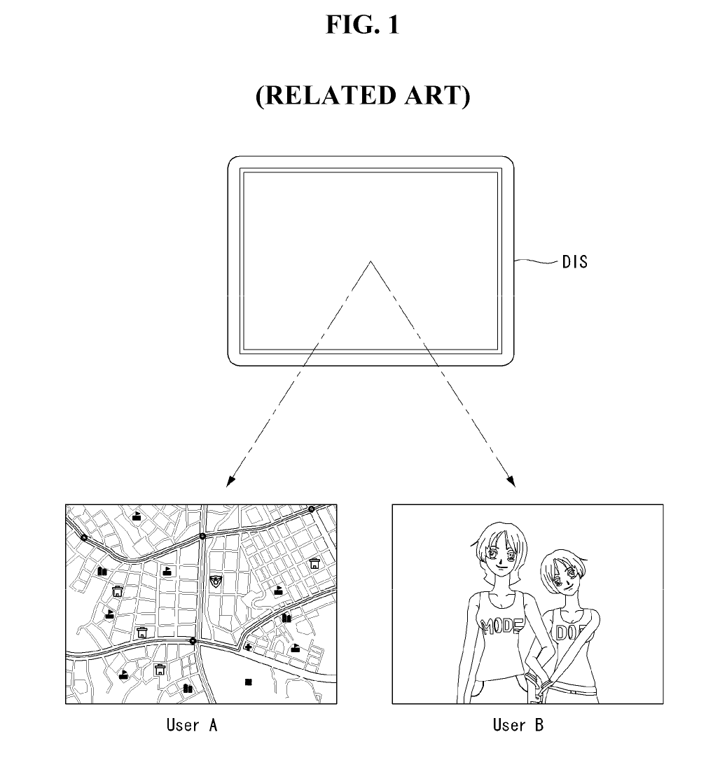

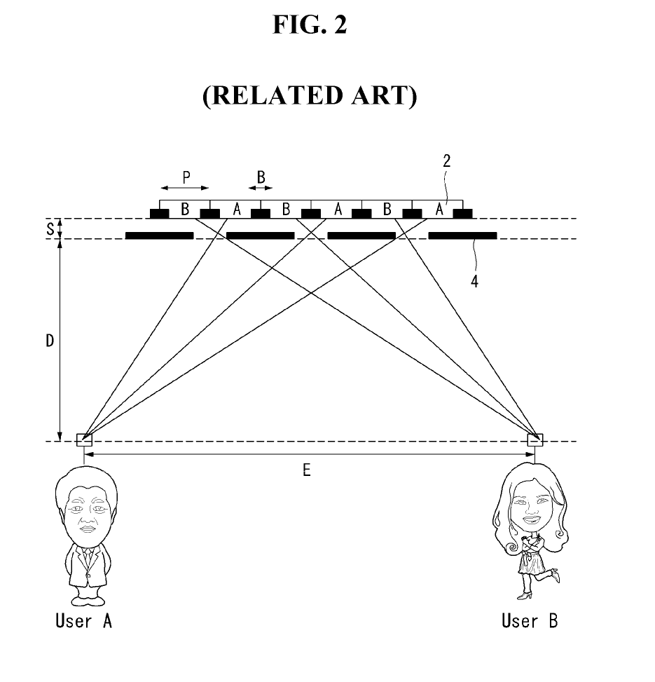

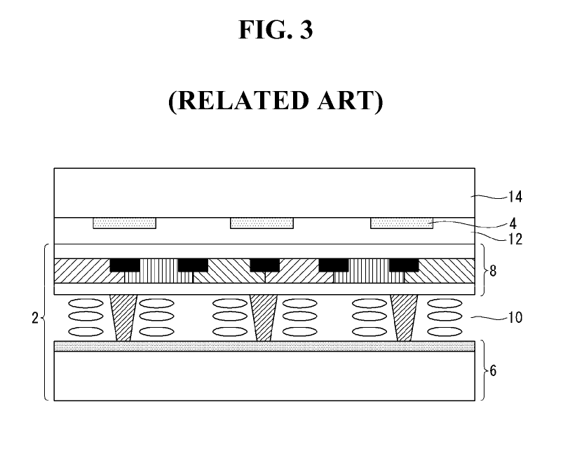

### DETAILED DESCRIPTION

Hereinafter, exemplary embodiments according to the present invention will be described in detail with reference to the attached drawings. Throughout the specification, like reference numerals denote substantially like components. In the following description, if it is decided that the detailed description of known function or configuration related to the invention makes the subject matter of the invention unclear, the detailed description is omitted.

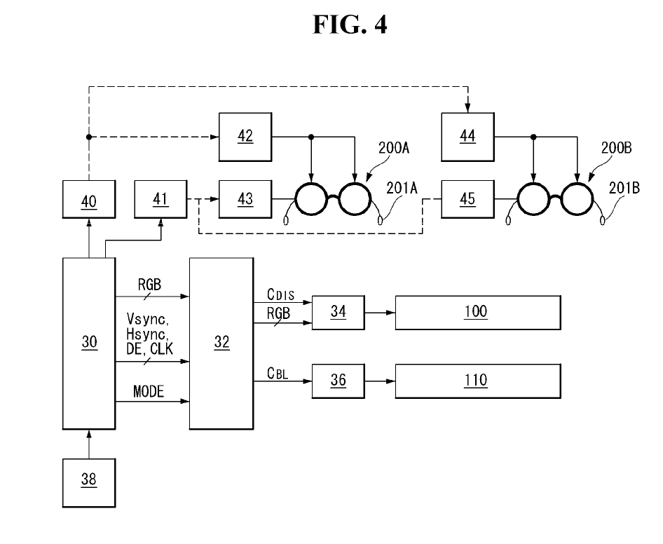

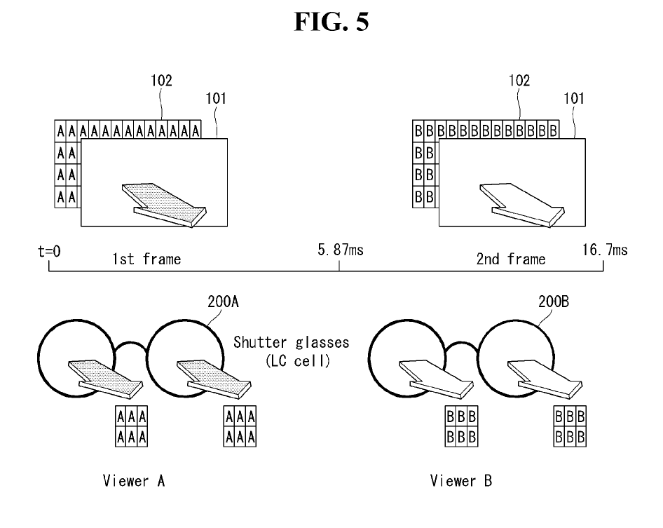

FIGS. 4 and 5 are views showing a multi view and stereoscopic image display according to a first exemplary embodiment of the present invention.

Referring to FIGS. 4 and 5, the multi view and stereoscopic image display according to the present invention comprises a display panel 100, a plurality of shutter glasses 200A and 200B, a display panel driving circuit 34, and a display panel controller 32.

The display panel 100 may be implemented as display panels including a liquid crystal display LCD, a field emission displays (FED), a plasma display panel (PDP), an electroluminescence device (EL) such as an organic light emitting diode (OLED), or an electrophoresis (EPD). The display panel 100 comprises data lines to which data voltages (or data currents) are supplied, gate lines (or scan lines), crossing the data lines, to which gate pulses (or scan pulses) are sequentially supplied, and a pixel array 102 disposed in matrix form. Each of the pixels of the pixel array 102 may comprise a TFT formed at each crossing of the data lines and the gate lines, and for supplying the data voltages from the data lines to the pixel electrodes of the pixel in response to the gate pulses from the gate lines.

When the display panel 100 is implemented as a liquid crystal display (LCD), the multi view and stereoscopic image display according to the present invention further comprises a backlight unit 110 and a backlight driving circuit 26. The backlight unit 110 is disposed behind the display panel 100 so as to face the back surface of the display panel 100. The backlight unit 110 may be implemented as a direct type backlight unit or an edge type backlight unit. The light sources of the backlight unit 110 may comprise one or two of a hot cathode fluorescent lamp (HCFL), a cold cathode fluorescent lamp (CCFL), an external electrode fluorescent lamp (EEFL), and a light emitting diode (LED). The backlight drive circuit 36 generates driving power for turning on the light source of the backlight unit 110 under control of the display panel controller 32.

In general 2D mode, the display panel 100 displays one 2D content image. In multi view mode, the display panel 100 displays a viewer A image and a viewer B image in a time-division manner. In the multi view mode, the viewer A image and the viewer B image are displayed in a time-division manner in units of frame periods. In the 3D mode, the display panel 100 displays the left-eye and right-eye images of a 3D image in a time-division manner in units of frame periods. In the multi view mode, the viewer A image and the viewer B image are 2D images not different between the left and right eyes, or may be images of different content or images of the same content. The content of the 3D image of the viewer A and the content of the 3D image of the viewer B may be images of the same content, taking the resolution of the display panel 100 into account, or may be selected as images of different content in a display panel having a high resolution.

The display panel driving circuit 34 comprises a data driving circuit and a gate driving circuit (or scan driving circuit). The data driving circuit converts 2D/3D digital video data input from the display panel controller 32 into a gamma compensation voltage to supply it to the data lines of the display panel 100. The gate driving circuit sequentially supplies gate pulses synchronized with the data voltages supplied to the data lines to the gate lines of the display panel 100 under control of the display panel controller 32.

The display panel controller 32 supplies digital video data RGB of 2D/3D images input from the host system 30 to the data driving circuit of the display panel driving circuit 34. The display panel controller 32 receives timing signals such as a vertical synchronization signal, a horizontal synchronization signal, a data enable signal, and a dot clock, and generates control signals CDIS for controlling operation timings of the data driving circuit and gate driving circuit of the display panel driving circuit 34. Further, the display panel controller generates a boost/dimming control signal CBL for controlling the on/off timing of the backlight unit and adjusting the backlight luminance.

The display panel controller 32 can switch the operation mode of the display panel driving circuit 34 to 2D mode and the multi view mode thereof to 3D mode in response to a mode signal MODE input from the host system 30.

The host system 30 may be connected to external video source devices, for example, a navigation system, a set-top box, a DVD player, a Blue-ray player, a personal computer (PC), and a home theater system, to receive input image data from the external video source devices. The host system 30 comprises a system-on-chip (hereinafter, “SoC”) having a scaler incorporated therein to convert image data from the external video sources into a data format with a resolution appropriate to display it on the display panel 100. The host system 30 transmits image data of content selected by a viewer to the display panel controller 32 in response to viewer data input thorough a viewer input device 38. Also, the host system 30 can generate a mode signal MODE in response to a viewer command input through the viewer input device 38 to set or change the current operation mode. The viewer input device 38 may comprise a navigation keypad, a keyboard, a mouse, an on-screen display (OSD), a remote controller, a touch screen, etc.

The host system 30 outputs a shutter control signal through the shutter control signal transmission unit 40 to open and close the left-eye and right-eye filters of the shutter glasses 200A and 200B. The shutter control signal independently controls the shutter glasses 200A and 200B. The shutter control signal may comprise an identification code for distinguishing the first shutter glasses 200A from the second shutter glasses 200B.

The shutter control signal transmission unit 40 transmits a shutter control signal to a shutter control signal reception unit through a wired/wireless interface. The shutter control signal reception unit comprises a first shutter control signal reception unit 42 incorporated in the first shutter glasses 200A or manufactured in a separate module to be attached to or detached from the first shutter glasses 200A and a second shutter control signal reception unit 44 incorporated in the second shutter glasses 200B or manufactured in a separate module to be attached or detached from the second shutter glasses 200B.

The host system 30 may transmit audio data synchronized with images displayed on the display panel to the shutter glasses 200A and 200B through a short-range communication transmitting unit 41. The audio data varies according to an image the viewer is seeing. If the image the viewer A is seeing and the image the viewer B is seeing are different, the audio data to be transmitted to the shutter glasses 200A worn by the viewer A and the audio data to be transmitted to the shutter glasses 200B worn by the viewer B are also different from each other. A short-range communication receiving unit comprises a first short-range communication receiving unit 43 incorporated in the first shutter glasses 200A and manufactured in a separate module to be attached to or detached from the first shutter glasses 200A and a second short-range communication receiving unit 45 incorporated in the second shutter glasses 200B or manufactured in a separate module to be attached to or detached from the second shutter glasses 200B. The first and second short-range communication receiving units 43 and 45 output received audio data through speakers 201A and 201B connected to the shutter glasses 200A and 200B. The short-range communication technologies may include Bluetooth, Radio Frequency Identification (RFID), InfraRed Data Association (IrDA), Ultra Wideband (UWB), ZigBee, etc.

The shutter glasses 200A and 200B are electrically controlled, respectively, each of which comprises a left-eye filter and a right-eye filter for transmitting and blocking light using a birefringent medium for adjusting light transmittance. The birefringent medium may be liquid crystal. Each of the left-eye and right-eye filters may comprise a first transparent substrate, a first transparent electrode formed on the first transparent substrate, a second transparent substrate, a second transparent electrode formed on the second transparent substrate, and a liquid crystal layer sandwiched between the first and second transparent substrates. Each of the left-eye and right-eye filters may comprise a polarization filter. The first transparent electrode is supplied with a reference voltage, and the second transparent electrode is supplied with an ON/OFF voltage. Each of the left-eye and right-eye filters transmits incident light toward the viewer's eye when an ON voltage is applied to the second transparent electrode, and blocks the light transmitted toward the viewer's eye when an OFF voltage is applied to the second transparent electrode.

When the multi view and stereoscopic image display according to the first exemplary embodiment of the present invention operates in general 2D mode to display a general 2D image, the viewers A and B can see the 2D image without putting on the shutter glasses 200A and 200B.

When the multi view and stereoscopic image display according to the first exemplary embodiment of the present invention operates in multi view mode to display 2D images of different content, the viewers A and B can see the 2D images of different content by putting on the shutter glasses 200A and 200B.

When the multi view and stereoscopic image display according to the first exemplary embodiment of the present invention operates in 3D mode to display a 3D image, the viewers A and B can see the 3D image by putting on the shutter glasses 200A and 200B. The host system 30 controls the operations of the shutter glasses 200A and 200B differently in the multi view mode and the 3D mode through shutter control signals.

In the multi view mode, the left-eye and right-eye filters of the first shutter glasses 200A worn by the viewer A are simultaneously opened in synchronization with a viewer A image displayed on the display panel 100, to thereby transmit the light of the viewer A image, and simultaneously block the light when viewer B image data is displayed on the display panel 100. The left-eye and right-eye filters of the second shutter glasses 200B worn by the viewer B are simultaneously opened in synchronization with a viewer B image displayed on the display panel 100, to thereby transmit the light of the viewer B image, and simultaneously block the light when viewer A image data is displayed on the display panel 100.

FIG. 5 is a view illustrating a multi view mode operation in the multi view and stereoscopic image display according to the first exemplary embodiment of the present invention. In FIG. 5, reference numeral ‘101’ denotes an upper polarization plate to be bonded to an upper transparent substrate of the display panel 100, and ‘102’ denotes a pixel array of the display panel 100.

Referring to FIG. 5, the viewer A can see the viewer A image displayed on the display panel 100 in an n-th frame period (n is a natural number) by putting on the first shutter glasses 200A. During the n-th frame period, the left-eye and right-eye filters of the first shutter glasses 200A are simultaneously opened in response to a shutter control signal; while the left-eye and right-eye filters of the second shutter glasses 200B are closed in response to a shutter control signal. The viewer A can hear audio information synchronized with the viewer A image through the speaker 201A connected to the first shutter glasses 200A.

The viewer B can see the viewer B image displayed in an (n+1)-th frame periods by putting on the second shutter glasses 200B. During the (n+1)-th frame period, the left-eye and right-eye filters of the first shutter glasses 200A are closed in response to a shutter control signal; while the left-eye and right-eye filters of the second shutter glasses 200B are simultaneously opened in response to a shutter control signal. The viewer B can hear audio information synchronized with the viewer B image through the speaker 201B connected to the second shutter glasses 200B.

In the multi view mode, two or more viewers may see different images. For example, the display panel 100 may display the viewer A image in the n-th frame period, then display the viewer B image in the (n+1)-th frame period, and then display a viewer C image in an (n+2)-th frame period. The left-eye and right-eye filters of the first shutter glasses worn by the viewer A transmit the light of the viewer A image during the n-th frame period, and blocks the light from the display panel 100 when the viewer B and c images are displayed on the display panel 100. The left-eye and right-eye filters of the second shutter glasses worn by the viewer B transmit the light of the viewer B image during the (n+1)-th frame period, and blocks the light from the display panel 100 when the viewer A and C images are displayed on the display panel 100. The left-eye and right-eye filters of third shutter glasses worn by a viewer C transmit the light of the viewer C image during the (n+2)-th frame period, and blocks the light from the display panel 100 when the viewer A and B images are displayed on the display panel 100.

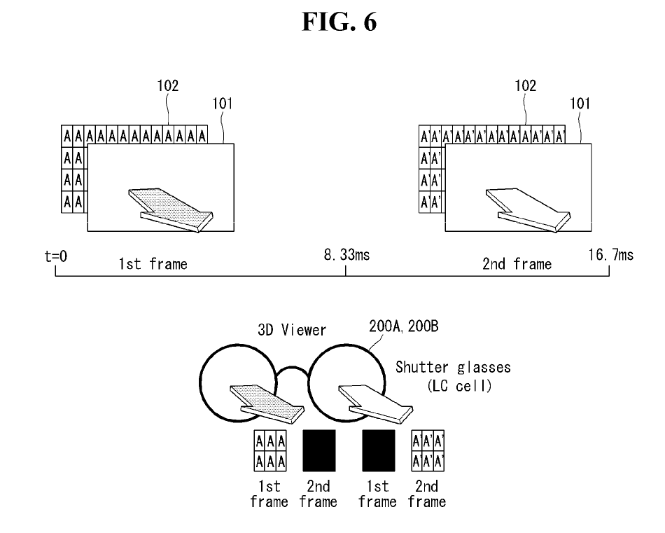

FIG. 6 is a view illustrating a 3D mode operation in the multi view and stereoscopic image display according to the first exemplary embodiment of the present invention.

Referring to FIG. 6, the viewers can see the left-eye image A displayed on the display panel 100 in the n-th frame period through the left-eye filters of the shutter glasses 200A and 200B. During the n-th frame period, the left-eye filters of the shutter glasses 200A and 200B are simultaneously opened in response to a shutter control signal; while the right-eye filters of the shutter glasses 200A and 200B are closed in response to a shutter control signal. The viewers can see the right-eye image A′ displayed on the display panel 100 in the (n+1)-th frame period through the right-eye filters of the shutter glasses 200A and 200B. During the (n+1)-th frame period, the left-eye filters of the shutter glasses 200A and 200B are closed in response to a shutter control signal; while the right-eye filters of the shutter glasses 200A and 200B are simultaneously opened in response to a shutter control signal. The viewers can hear audio information synchronized with a 3D image through the speakers 201A and 201B connected to the shutter glasses 200A and 200B.

In examples of operations of the multi view mode and 3D mode of FIGS. 5 and 6, the frame frequency is 120 Hz, but not limited thereto. For instance, the frame frequency may be increased to 240 Hz.

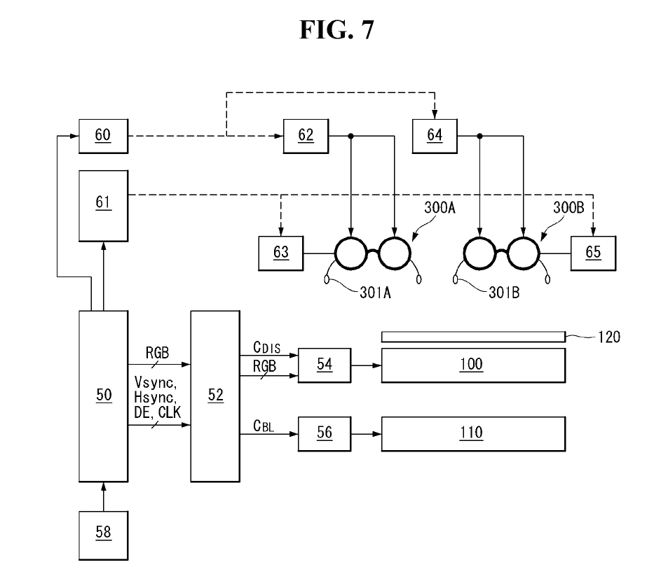

FIGS. 7 to 13 are views showing a multi view and stereoscopic image display according to a second exemplary embodiment of the present invention.

Referring to FIG. 7, the multi view and stereoscopic image display of the present invention comprises a display panel 100, a pattern retarder 120 attached on the display panel 100, a plurality of active polarization glasses 300A and 300B, a display panel driving circuit 54, and a display panel controller 52.

The display panel 100 may be implemented as display panels including a liquid crystal display LCD, a field emission displays (FED), a plasma display panel (PDP), an electroluminescence device (EL) such as an organic light emitting diode (OLED), or an electrophoresis (EPD). The display panel 100 comprises data lines to which data voltages (or data currents) are supplied, gate lines (or scan lines), crossing the data lines, to which gate pulses (or scan pulses) are sequentially supplied, and a pixel array 102 disposed in matrix form. Each of the pixels of the pixel array 102 may comprise a TFT formed at each crossing of the data lines and the gate lines, and for supplying the data voltages from the data lines to the pixel electrodes of the pixel in response to the gate pulses from the gate lines.

In general 2D mode, the display panel 100 displays one 2D content image in general 2D mode. In multi view mode, the display panel 100 displays a viewer A image and a viewer B image separately by line. For example, the viewer A image may be displayed in odd-numbered lines, and the viewer B image may be displayed in an even-numbered line. In 3D mode, the display panel 100 displays a 3D image comprising a left-eye image and a right-eye image. The left-eye image and right-eye image of the 3D image are separately displayed by line on the display panel 100. For example, the left-eye image may be displayed in the odd-numbered lines of the display panel 10, and the right-eye image may be displayed in the even-numbered lines of the display panel 100.

The data driving circuit converts 2D/3D digital video data input from the display panel controller 52 into a gamma compensation voltage to supply it to the data lines of the display panel 100. The gate driving circuit sequentially supplies gate pulses synchronized with the data voltages supplied to the data lines to the gate lines of the display panel 100 under control of the display panel controller 52.

When the display panel 100 is implemented as a liquid crystal display (LCD), the multi view and stereoscopic image display according to the present invention further comprises a backlight unit 110 and a backlight driving circuit 56. The backlight drive circuit 56 generates driving power for turning on the light source of the backlight unit 110 under control of the display panel controller 52.

The pattern retarder 120 is bonded to the display panel 100 to differentiate the polarization properties of the odd-numbered lines of the display panel 100 and the polarization properties of the even-numbered lines of the display panel 100. The pattern retarder 120 comprises a first retarder 121 facing the odd-numbered lines of the pixel array 102 and a second retarder 122 facing the even-numbered lines of the pixel array 102. The first retarder 121 only transmits the light of the first polarization, and the second retarder 122 only transmits the light of the second polarization. Of the light of the image displayed on the pixels of the odd-numbered lines of the pixel array 102, only the light of the first polarization passes through the first retarder 121. Of the light of the image displayed on the pixels of the even-numbered lines of the pixel array 102, only the light of the second polarization passes through the second retarder 122. Here, the first and second polarizations may be linear polarizations or circular polarizations having different optical axes. For example, as shown in FIGS. 7 to 13, the first polarization may be a left circular polarization, and the second polarization may be a right circular polarization.

The display panel controller 52 supplies digital video data RGB of 2D/3D images input from the host system 50 to the data driving circuit of the display panel driving circuit 54. The display panel controller 52 receives timing signals such as a vertical synchronization signal, a horizontal synchronization signal, a data enable signal, and a dot clock, and generates control signals CDIS for controlling operation timings of the data driving circuit and gate driving circuit of the display panel driving circuit 54. Further, the display panel controller generates a boost/dimming control signal CBL for controlling the on/off timing of the backlight unit and adjusting the backlight luminance.

The display panel controller 52 can switch the operation mode of the display panel driving circuit 54 to 2D mode and the multi view mode thereof to 3D mode in response to a mode signal MODE input from the host system 50.

The host system 50 may be connected to external video source devices. The host system 50 comprises a system-on-chip (hereinafter, “SoC”) having a scaler incorporated therein to convert image data from the external video sources into a data format with a resolution appropriate to display it on the display panel 100. The host system 50 transmits image data of content selected by a viewer to the display panel controller 52 in response to viewer data input thorough a viewer input device 58. Also, the host system 50 can generate a mode signal MODE in response to a viewer command input through the viewer input device 58 to set or change the current operation mode.

The host system 50 outputs a shutter control signal through the shutter control signal transmission unit 60 to change the left-eye and right-eye filters of the active polarization glasses 300A and 300B. The shutter control signal independently controls the active polarization glasses 300A and 300B. The shutter control signal may comprise an identification code for distinguishing the first active polarization glasses 300A from the second active polarization glasses 300B.

The shutter control signal transmission unit 60 transmits a shutter control signal to a shutter control signal reception unit through a wired/wireless interface. The shutter control signal reception unit comprises a first shutter control signal reception unit 62 incorporated in the first active polarization glasses 300A or manufactured in a separate module to be attached to or detached from the first active polarization glasses 300A and a second shutter control signal reception unit 64 incorporated in the second active polarization glasses 300B or manufactured in a separate module to be attached or detached from the second active polarization glasses 300B.

The host system 50 may transmit audio data synchronized with images displayed on the display panel 100 to the active polarization glasses 300A and 300B through a short-range communication transmitting unit 61. The audio data varies according to an image the viewer is seeing. If the image the viewer A is seeing and the image the viewer B is seeing are different, the audio data to be transmitted to the active polarization glasses 300A worn by the viewer A and the audio data to be transmitted to the active polarization glasses 300B worn by the viewer B are also different from each other. A short-range communication receiving unit comprises a first short-range communication receiving unit 63 incorporated in the first active polarization glasses 300A and manufactured in a separate module to be attached to or detached from the first active polarization glasses 300A and a second short-range communication receiving unit 65 incorporated in the second active polarization glasses 300B or manufactured in a separate module to be attached to or detached from the second active polarization glasses 300B. The first and second short-range communication receiving units 63 and 65 output received audio data through speakers 301A and 301B connected to the active polarization glasses 300A and 300B.

The conventional polarization glasses have fixed polarization properties corresponding to the polarization properties of a pattern retarder. For example, in polarization glasses corresponding to the stereoscopic image display of the conventional pattern retarder type, the left-eye filter and the right-eye filter have different polarization properties from each other and the polarization properties are fixed. In contrast, in the active polarization glasses 300A and 300B of the present invention, the polarization properties of the left-eye filter and the right-eye filter may be changed by polarization switching cells 303 and 307.

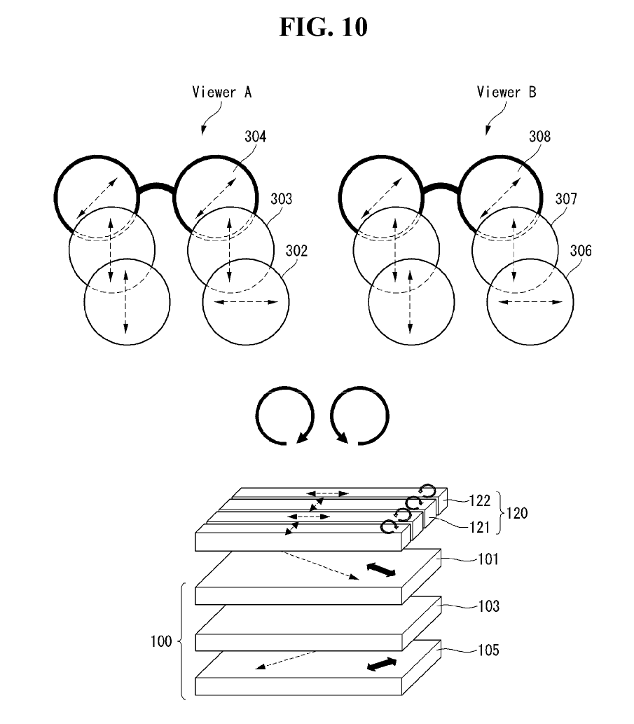

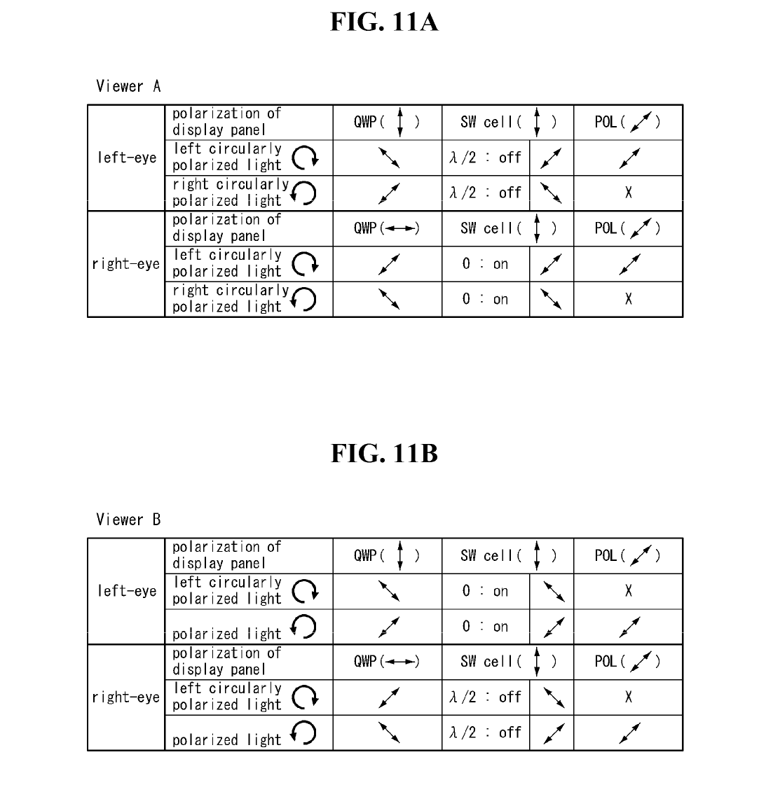

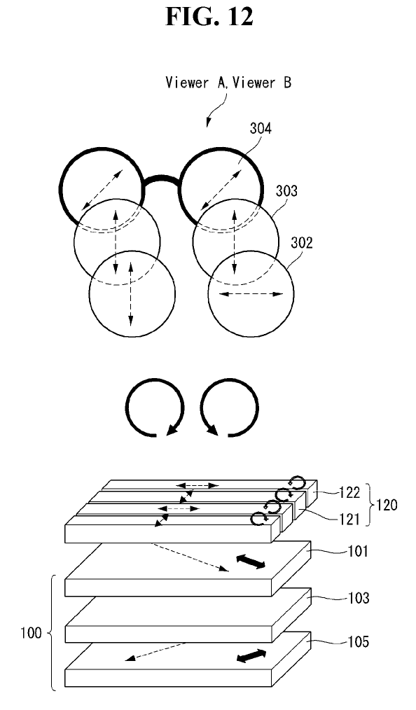

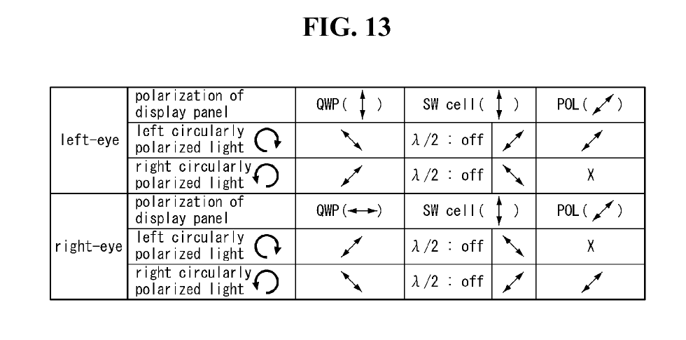

The left-eye filter and right-eye filter of the active polarization glasses 300A and 300B adjust the polarization properties using the polarization switching cells 303 and 307 that are electrically individually controlled. As shown in FIGS. 10 and 12, each of the left-eye and right-eye filters of the active polarization glasses 300A and 300B comprises a ¼ wave plate (QWP) 302 and 306, a polarization switching cell 303 and 307, electrodes for applying an electric field, and a ½ wave plate 304 and 308. In FIGS. 11a, 11b, and 13, “QWP” denotes the ¼ wave plate 302 and 306, “SW cell” denotes the polarization switching cell 303 and 307, and POL denotes the ½ wave plate 304 and 308.

The polarization switching cells 303 and 307 are electrically controlled to let incident light pass therethrough without delaying the phase of the incident light, or to delay the phase of incident light by ½ wave length. The polarization switching cells 303 and 307 may comprise a birefringent medium such as liquid crystal. As shown in FIGS. 10 to 13, the polarization switching cells 303 and 307 delay the phase of incident light by ½ wavelength when no electric field is applied (Off), and pass the incident light through when an electric field is applied (On).

In the active polarization glasses 300A and 300B, the optical axis of the ¼ wave plate 302 and 306 formed at the left-eye filter substantially crosses the ¼ wave plate 302 and 306 formed at the right-eye filter. In the active polarization glasses 300A and 300B, the optical axis of the ½ wave plate 304 and 308 formed at the left-eye filter and the right-eye filter are substantially equal.

In the active polarization glasses 300A and 300B, the ¼ wave plate 302 and 306 formed at the left-eye filter delays the phase of a left circularly polarized light having passed through a first retarder 121 along a vertical optical axis by ¼ wavelength to convert it into a first linearly polarized light vibrating along the optical axis of −45°, and delays the phase of a right circularly polarized light having passed through a second retarder 122 by ¼ wavelength to convert it into a second linear circular light vibrating along the optical axis of 45° The ¼ wave plate 302 and 306 formed at the right-eye filter delays the phase of a right circularly polarized light having passed through the second retarder 122 along a horizontal optical axis by ¼ wavelength to convert it into a first linearly polarized light vibrating along the optical axis of −45°, and delays the phase of a left circularly polarized light having passed through the first retarder 121 to convert it into a second linear circular light vibrating along the optical axis of 45° by ¼ wavelength. In the active polarization glasses 300A and 300B, the ½ wave plates 304 and 308 formed at the left-eye and right-eye filters transmit only the second linearly polarized light vibrating along the optical axis of 45°.

When the multi view and stereoscopic image display according to the second exemplary embodiment of the present invention operates in general 2D mode to display a general 2D image, the viewers A and B can see the 3D image without putting on the active polarization glasses 300A and 300B.

When the multi view and stereoscopic image display according to the second exemplary embodiment of the present invention operates in multi view mode to display 2D images of different content, the viewers A and B can see the 2D images of different content by putting on the active polarization glasses 300A and 300B.

When the multi view and stereoscopic image display according to the second exemplary embodiment of the present invention operates in 3D mode to display a 3D image, the viewers A and B can see the 3D image by putting on the active polarization glasses 300A and 300B. The host system 50 controls the polarization properties of the left-eye and right-eye filters of the active polarization glasses 300A and 300B differently in the multi view mode and the 3D mode through shutter control signals.

In the multi view mode, the left-eye and right-eye filters of the first active polarization glasses 300A worn by the viewer A allow the light having passed through the first retarder 121 of the pattern retarder 120 to pass therethrough, and block the light having passed through the second retarder 122 of the pattern retarder 120. The second active polarization glasses 300B worn by the viewer B allow the light having passed through the second retarder 122 of the pattern retarder 120, and block the light having passed through the first retarder 121 of the pattern retarder 120.

In the multi view mode, as shown in FIGS. 10 and 11a, the polarization switching cell 303 formed at the left-eye filter of the first active polarization glasses 300A worn by the viewer A delays the phase of the first linearly polarized light having passed through the ¼ wave plate 302 by ½ wavelength to convert it into the second linearly polarized light. Accordingly, the light of the left circular polarization incident on the left-eye filter of the first active polarization glasses 300A passes through the polarization switching cell 303 of the ¼ wave plate 302, and is converted into the second linearly polarized light capable of passing through the ½ wave plate 304 and incident on the left eye of the viewer. As shown in FIGS. 10 and 11a, the polarization switching cell 303 formed at the right-eye filter of the first active polarization glasses 300A allows the second linearly polarized light having passed through the ¼ wave plate 302 to pass therethrough without delaying the phase thereof. Accordingly, the light of the left circular polarization incident on the right-eye filter of the first active polarization glasses 300A passes through the ¼ wave plate 302, the polarization switching cell 303, and the ½ wave plate 304, and is incident on the right eye of the viewer.

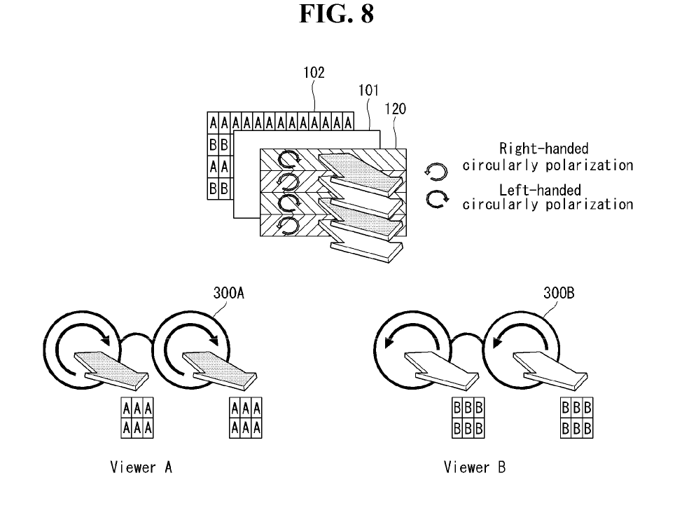

As a result, as shown in FIGS. 8, 10, and 11a, the left eye and right eye of the viewer A can see the viewer A image passing through the first retarder 121 of the pattern retarder 120.

As shown in FIGS. 10 and 11b, the polarization switching cell 307 formed at the left-eye filter of the second active polarization glasses 300B worn by the viewer B allows the second linearly polarized light having passed through the ¼ wave plate 306 to pass therethrough without delaying the phase thereof. Accordingly, the light of the right circular polarization incident on the left-eye filter of the second active polarization glasses 300B passes through the ¼ wave plate 306, the polarization switching cell 307, and the ½ wave plate 308, and is incident on the left eye of the viewer.

As shown in FIGS. 10 and 11b, the polarization switching cell 307 formed at the right-eye filter of the second active polarization glasses 300B delays the phase of the first linearly polarized light having passed through the ¼ wave plate 306 by ½ wavelength. Accordingly, the light of the right circular polarization incident on the left-eye filter of the second active polarization glasses 300B passes through the ¼ wave plate 306, the polarization switching cell 307, and the ½ wave plate 308, and is incident on the right eye of the viewer. As a result, as shown in FIGS. 8, 10, and 11b, the left eye and right eye of the viewer B can see the viewer B image passing through the second retarder 122 of the pattern retarder 120.

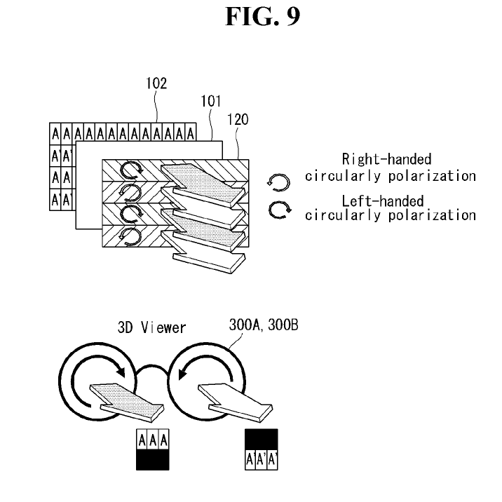

In the 3D mode, the left-eye filter of the active polarization glasses 300A and 300B allows the light having passed through the first retarder 121 of the pattern retarder 120 to pass therethrough, and the left-eye filter thereof allows the light having passed through the second retarder 122 of the pattern retarder 120 to pass therethrough. As shown in FIGS. 12 and 13, the polarization switching cell 303 and 307 formed at the left-eye filter of the active polarization glasses 300A and 300B delays the phase of the first linearly polarized light having passed through the ¼ wave plate 302 and 306 by ½ wavelength to convert it into the second linearly polarized light that can pass therethrough the ½ wave plate 304 and 308. As shown in FIGS. 12 and 13, the polarization switching cell 303 and 307 formed at the right-eye filter of the active polarization glasses 300A and 300B delays the phase of the first linearly polarized light having passed through the ¼ wave plate 302 and 306 by ½ wavelength to convert it into the second linearly polarized light that can pass through the ½ wave plate 304 and 308. As a result, as shown in FIGS. 9, 12, and 13, the left eyes of the viewers see the left-eye image A of the 3D image passing through the first retarder 121 of the pattern retarder 120, and the right eyes of the viewers see the right-eye image A′ of the 3D image passing through the second retarder 122 of the pattern retarder 120.

In FIGS. 11a, 11b, and 13, the arrows denote optical axis in a polarization direction, and “X” denote light that cannot pass through the ½ wave plates 304 and 308 of the active polarization glasses 300A and 300B.

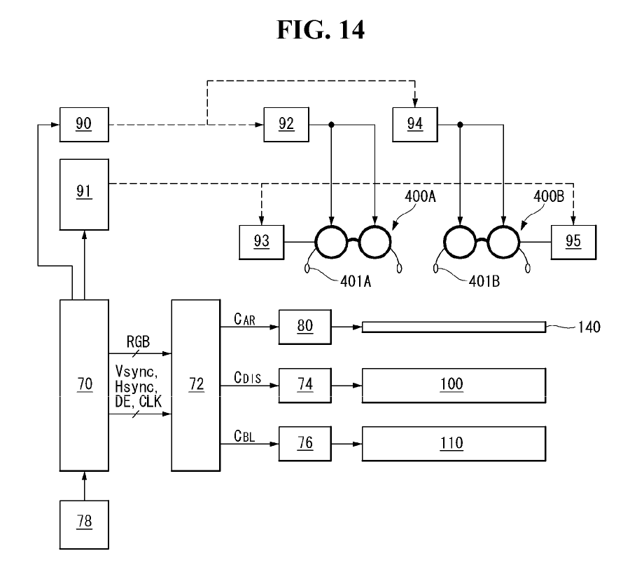

FIGS. 14 to 20 are views showing a multi view and stereoscopic image display according to a third exemplary embodiment of the present invention.

Referring to FIG. 14, the multi view and stereoscopic image display of the present invention comprises a display panel 100, an active retarder 140 attached on the display panel 100, a plurality of active polarization glasses 400A and 400B, a display panel driving circuit 74, and a display panel controller 72.

The display panel 100 may be implemented as display panels including a liquid crystal display LCD, a field emission displays (FED), a plasma display panel (PDP), an electroluminescence device (EL) such as an organic light emitting diode (OLED), or an electrophoresis (EPD). The display panel 100 comprises data lines to which data voltages (or data currents) are supplied, gate lines (or scan lines), crossing the data lines, to which gate pulses (or scan pulses) are sequentially supplied, and a pixel array 102 disposed in matrix form. Each of the pixels of the pixel array 102 may comprise a TFT formed at each crossing of the data lines and the gate lines, and for supplying the data voltages from the data lines to the pixel electrodes of the pixel in response to the gate pulses from the gate lines.

In 2D mode, the display panel 100 displays a 2D image. In multi view mode, the display panel 100 displays a viewer A image and a viewer B image in a time-division manner. In the multi view mode, the viewer A image and the viewer B image are displayed in a time-division manner in units of frame periods. In the 3D mode, the display panel 100 displays the left-eye and right-eye images of a 3D image in a time-division manner in units of frame periods.

The data driving circuit converts 2D/3D digital video data input from the display panel controller 72 into a gamma compensation voltage to supply it to the data lines of the display panel 100. The gate driving circuit sequentially supplies gate pulses synchronized with the data voltages supplied to the data lines to the gate lines of the display panel 100 under control of the display panel controller 72.

When the display panel 100 is implemented as a liquid crystal display (LCD), the multi view and stereoscopic image display according to the present invention further comprises a backlight unit 110 and a backlight driving circuit 76. The backlight drive circuit 76 generates driving power for turning on the light source of the backlight unit 110 under control of the display panel controller 72.

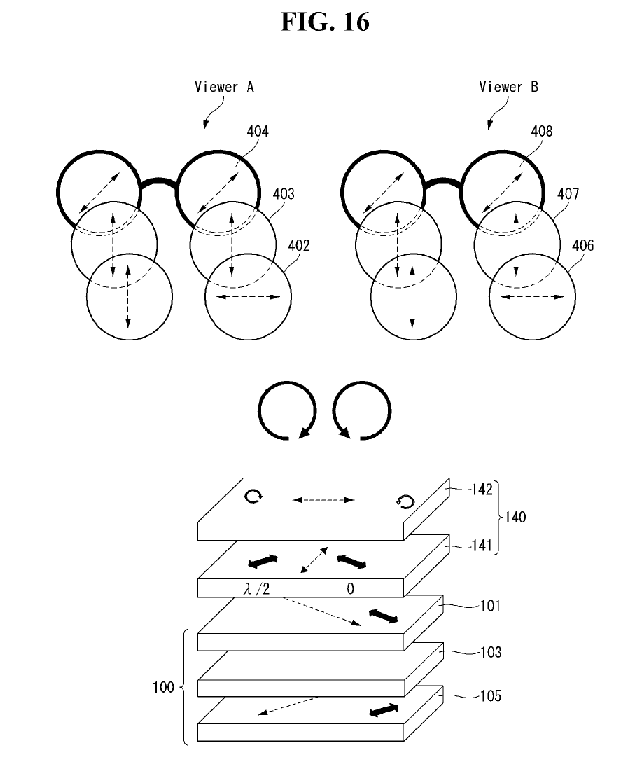

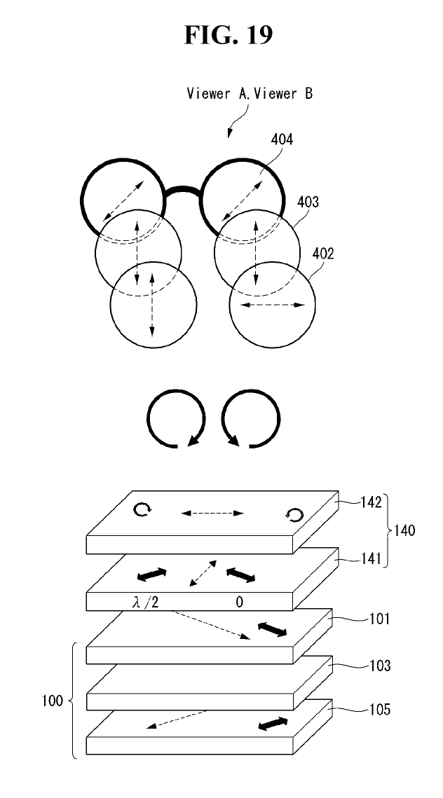

As shown in FIGS. 16 and 19, the active retarder 140 comprises a liquid crystal layer 141, electrodes for applying an electric field to the liquid crystal layer 141, and a ¼ wave plate 142 formed on the liquid crystal layer 141, and electrically controls the birefringent state of the liquid crystal layer to convert the polarization properties of light incident from the display panel 100. The liquid crystal layer 141 allows incident light to pass therethrough in response to an on voltage without delaying the phase thereof; whereas it serves as a ½ wavelength phase delay layer for delaying the phase of incident light by ½ wavelength when an off voltage is applied. During an n-th frame period, the liquid crystal layer 141 converts −45° linearly polarized light (first linearly polarized light) passing through the upper polarization plate 101 of the display panel 100 into 45° linearly polarized light (second linearly polarized light) in response to an off voltage by delaying the phase thereof by ½ wavelength, and the ¼ wave plate 142 converts the 45° linearly polarized light (second linearly polarized light) passing through the liquid crystal layer 141 into left circularly polarized light by delaying the phase thereof by ¼ wavelength. During an (n+1)-th frame period, the liquid crystal layer 141 allows the −45° linearly polarized light having passed through the upper polarization plate 101 of the display panel 100 to pass therethrough in response to an on voltage, and the ¼ wave plate 142 converts the −45° linearly polarized light having passed through the liquid crystal layer 141 into right circularly polarized light by delaying the phase thereof by ¼ wavelength.

The display panel controller 72 supplies digital video data RGB of 2D/3D images input from the host system 70 to the data driving circuit of the display panel driving circuit 74. The display panel controller 72 receives timing signals such as a vertical synchronization signal, a horizontal synchronization signal, a data enable signal, and a dot clock, and generates control signals CDIS for controlling operation timings of the data driving circuit and gate driving circuit of the display panel driving circuit 74. Further, the display panel controller generates a boost/dimming control signal CBL for controlling the on/off timing of the backlight unit and adjusting the backlight luminance.

The display panel controller 72 can switch the operation mode of the display panel driving circuit 74 to 2D mode and the multi view mode thereof to 3D mode in response to a mode signal MODE input from the host system 70.

The host system 70 may be connected to external video source devices. The host system 70 comprises a system-on-chip (hereinafter, “SoC”) having a scaler incorporated therein to convert image data from the external video sources into a data format with a resolution appropriate to display it on the display panel 100. The host system 70 transmits image data of content selected by a viewer to the display panel controller 72 in response to viewer data input thorough a viewer input device 58. Also, the host system 70 can generate a mode signal MODE in response to a viewer command input through the viewer input device 78 to set or change the current operation mode.

The host system 70 outputs a shutter control signal through the shutter control signal transmission unit 90 to change the left-eye and right-eye filters of the active polarization glasses 400A and 400B. The shutter control signal independently controls the active polarization glasses 400A and 400B. The shutter control signal may comprise an identification code for distinguishing the first active polarization glasses 400A from the second active polarization glasses 400B.

The shutter control signal transmission unit 90 transmits a shutter control signal to a shutter control signal reception unit through a wired/wireless interface. The shutter control signal reception unit comprises a first shutter control signal reception unit 92 incorporated in the first active polarization glasses 400A or manufactured in a separate module to be attached to or detached from the first active polarization glasses 400A and a second shutter control signal reception unit 94 incorporated in the second active polarization glasses 400B or manufactured in a separate module to be attached or detached from the second active polarization glasses 400B.

The host system 70 may transmit audio data synchronized with images displayed on the display panel 100 to the active polarization glasses 400A and 400B through a short-range communication transmitting unit 91. The audio data varies according to an image the viewer is seeing. If the image the viewer A is seeing and the image the viewer B is seeing are different, the audio data to be transmitted to the active polarization glasses 400A worn by the viewer A and the audio data to be transmitted to the active polarization glasses 400B worn by the viewer B are also different from each other. A short-range communication receiving unit comprises a first short-range communication receiving unit 93 incorporated in the first active polarization glasses 400A and manufactured in a separate module to be attached to or detached from the first active polarization glasses 400A and a second short-range communication receiving unit 95 incorporated in the second active polarization glasses 400B or manufactured in a separate module to be attached to or detached from the second active polarization glasses 400B. The first and second short-range communication receiving units 93 and 95 output received audio data through speakers 401A and 401B connected to the active polarization glasses 400A and 400B.

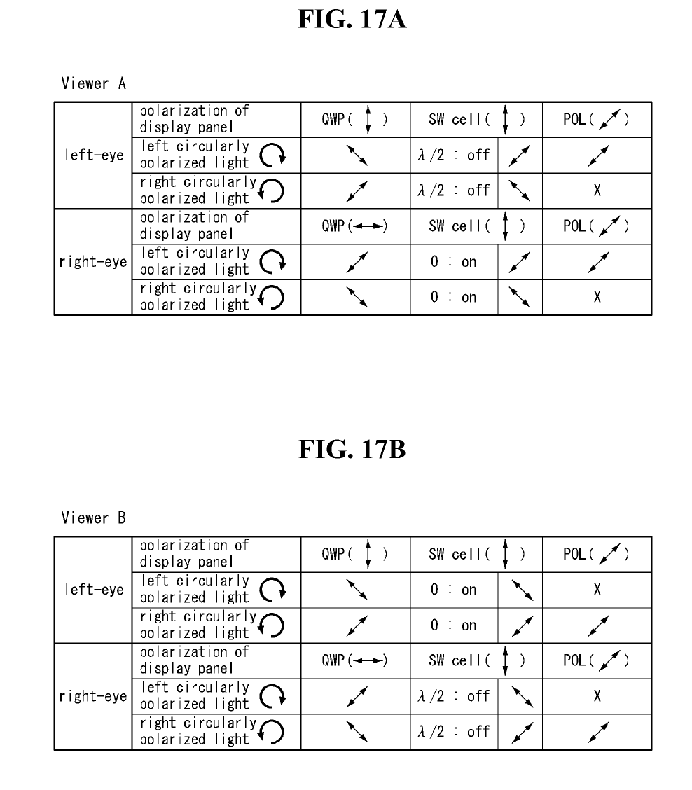

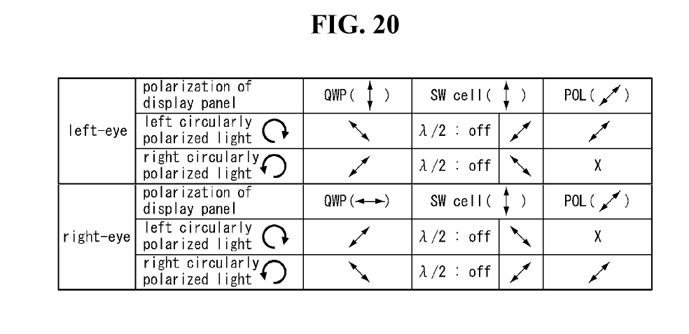

As shown in FIGS. 16 and 19, the left-eye filter and right-eye filter of the active polarization glasses 400A and 400B adjust the polarization properties using the polarization switching cells 403 and 407 that are electrically individually controlled. As shown in FIGS. 16 and 19, each of the left-eye and right-eye filters of the active polarization glasses 400A and 400B comprises a ¼ wave plate (QWP) 402 and 406, a polarization switching cell 403 and 407, electrodes for applying an electric field, and a ½ wave plate 404 and 408. In FIGS. 17a, 17b, and 20, “QWP” denotes the ¼ wave plate 402 and 406, “SW cell” denotes the polarization switching cell 403 and 407, and POL denotes the ½ wave plate 404 and 408.

The polarization switching cells 403 and 407 are electrically controlled to let incident light pass therethrough without delaying the phase of the incident light, or delay the phase of incident light by ½ wave length. The polarization switching cells 403 and 407 may comprise a birefringent medium such as liquid crystal. As shown in FIGS. 16 to 17b, FIG. 19, and FIG. 20, the polarization switching cells 403 and 407 delay the phase of incident light by ½ wavelength when no electric field is applied (Off), and pass the incident light through when an electric field is applied (On).

In the active polarization glasses 400A and 400B, the optical axis of the ¼ wave plate 402 and 406 formed at the left-eye filter substantially crosses the ¼ wave plate 402 and 406 formed at the right-eye filter. In the active polarization glasses 400A and 400B, the optical axis of the ½ wave plate 404 and 408 formed at the left-eye filter and the right-eye filter are substantially equal.

In the active polarization glasses 400A and 400B, the ¼ wave plate 402 and 406 formed at the left-eye filter delays the phase of a left circularly polarized light having passed through the active retarder 140 along a vertical optical axis by ¼ wavelength to convert it into a first linearly polarized light vibrating along the optical axis of −45°, and delays the phase of a right circularly polarized light having passed through the active retarder 140 by ¼ wavelength to convert it into a second linear circular light vibrating along the optical axis of 45°. The ¼ wave plate 402 and 406 formed at the right-eye filter delays the phase of a right circularly polarized light having passed through the active retarder 140 along a horizontal optical axis by ¼ wavelength to convert it into a first linearly polarized light vibrating along the optical axis of −45°, and delays the phase of a left circularly polarized light having passed through the active retarder 140 to convert it into a second linear circular light vibrating along the optical axis of 45° by ¼ wavelength. In the active polarization glasses 400A and 400B, the ½ wave plates 404 and 408 formed at the left-eye and right-eye filters transmit only the second linearly polarized light vibrating along the optical axis of 45°.

When the multi view and stereoscopic image display according to the third exemplary embodiment of the present invention operates in general 2D mode to display a general 2D image, the viewers A and B can see the 3D image without putting on the active polarization glasses 400A and 400B.

When the multi view and stereoscopic image display according to the third exemplary embodiment of the present invention operates in multi view mode to display 2D images of different content, the viewers A and B can see the 2D images of different content by putting on the active polarization glasses 400A and 400B.

When the multi view and stereoscopic image display according to the third exemplary embodiment of the present invention operates in 3D mode to display a 3D image, the viewers A and B can see the 3D image by putting on the active polarization glasses 400A and 400B. The host system 70 controls the polarization properties of the left-eye and right-eye filters of the active polarization glasses 400A and 400B differently in the multi view mode and the 3D mode through shutter control signals.

In the multi view mode, the left-eye and right-eye filters of the first active polarization glasses 400A worn by the viewer A allow the left circularly polarized light having passed through the active retarder 140 to pass therethrough, and block the right circularly polarized light. The second active polarization glasses 400B worn by the viewer B allow the right circularly polarized light having passed through the active retarder 140 to pass therethrough, and block the left circularly polarized light. In the multi view mode, the display panel 100 displays the viewer A image during the n-th frame period, and displays the viewer B image during the (n+1)-th frame period. As described above, the active retarder 140 allows the light of left circular polarization of the viewer A image to pass therethrough during the n-th frame period, and allows the light of right circular polarization of the viewer B image to pass therethrough during the (n+1)-th frame period.

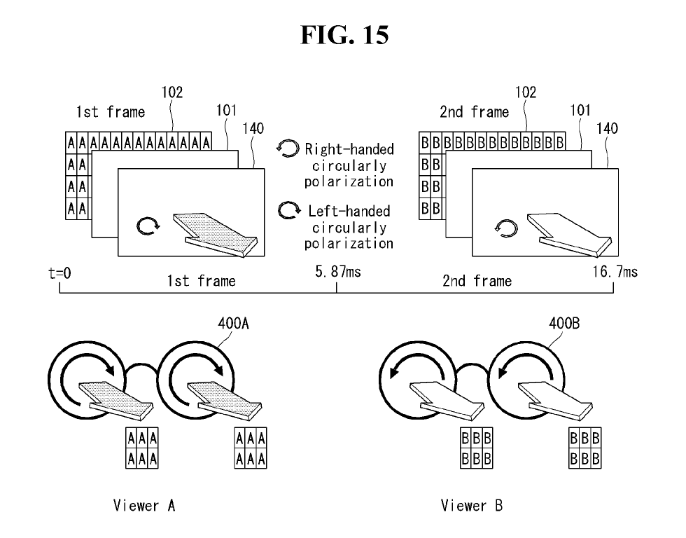

In the multi view mode, as shown in FIGS. 15 and 17a, the polarization switching cell 403 formed at the left-eye filter of the first active polarization glasses 400A worn by the viewer A delays the phase of the first linearly polarized light having passed through the ¼ wave plate 402 by ½ wavelength to convert it into the second linearly polarized light. Accordingly, the light of the left circular polarization incident on the left-eye filter of the first active polarization glasses 400A passes through the polarization switching cell 403 of the ¼ wave plate 402, and is converted into the second linearly polarized light capable of passing through the ½ wave plate 404 and incident on the left eye of the viewer. As shown in FIGS. 15 to 17a, the polarization switching cell 403 formed at the right-eye filter of the first active polarization glasses 400A allows the second linearly polarized light having passed through the ¼ wave plate 402 to pass therethrough without delaying the phase thereof. Accordingly, the light of the left circular polarization incident on the right-eye filter of the first active polarization glasses 400A passes through the ¼ wave plate 402, the polarization switching cell 403, and the ½ wave plate 404, and is incident on the right eye of the viewer. As a result, as shown in FIGS. 15 to 17a, the left eye and right eye of the viewer A can see the viewer A image passing through the active retarder 140 in the multi view mode during the n-th frame period.

As shown in FIG. 15, FIG. 16, and FIG. 17b, the polarization switching cell 407 formed at the left-eye filter of the second active polarization glasses 400B worn by the viewer B allows the second linearly polarized light having passed through the ¼ wave plate 406 to pass therethrough without delaying the phase thereof. Accordingly, the light of the right circular polarization incident on the left-eye filter of the second active polarization glasses 400B passes through the ¼ wave plate 406, the polarization switching cell 407, and the ½ wave plate 408, and is incident on the left eye of the viewer. As shown in FIG. 15, FIG. 16, and FIG. 17b, the polarization switching cell 407 formed at the right-eye filter of the second active polarization glasses 400B delays the phase of the first linearly polarized light having passed through the ¼ wave plate 406 by ½ wavelength. Accordingly, the light of the right circular polarization incident on the left-eye filter of the second active polarization glasses 400B passes through the ¼ wave plate 406, the polarization switching cell 407, and the ½ wave plate 408, and is incident on the right eye of the viewer. As a result, as shown in FIG. 15, FIG. 16, and FIG. 17b, the left eye and right eye of the viewer B can see the viewer B image passing through the active retarder 140.

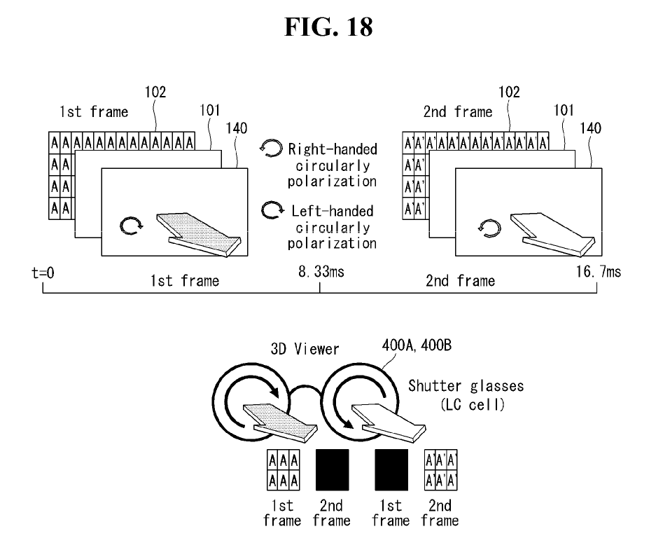

In the 3D mode, the left-eye filter of the active polarization glasses 400A and 400B allows only the left circularly polarized light having passed through the active retarder 140 to pass therethrough, and the left-eye filter thereof allows only the right circularly polarized light having passed through the active retarder 140 to pass therethrough. As shown in FIGS. 18 to 20, the polarization switching cell 403 and 407 formed at the left-eye filter of the active polarization glasses 400A and 400B delays the phase of the first linearly polarized light having passed through the ¼ wave plate 402 and 406 by ½ wavelength to convert it into the second linearly polarized light that can pass through the ½ wave plate 404 and 408. As shown in FIGS. 18 to 20, the polarization switching cell 403 and 407 formed at the right-eye filter of the active polarization glasses 400A and 400B delays the phase of the first linearly polarized light having passed through the ¼ wave plate 402 and 406 by ½ wavelength to convert it into the second linearly polarized light that can pass through the ½ wave plate 404 and 408. As a result, as shown in FIGS. 18 to 20, the left eyes of the viewers see the left-eye image A of the 3D image passing through the active retarder 140 during the n-th frame period, and the right eyes of the viewers see the right-eye image A′ of the 3D image passing through the active retarder 140 during the (n+1)-th frame period.

In FIGS. 17a, 17b, and 20, the arrows denote optical axis in a polarization direction, and “X” denote light that cannot pass through the ½ wave plates 404 and 408 of the active polarization glasses 400A and 400B.

In the above-described exemplary embodiments, the optical parts such as the ¼ wave plate and the ½ wave plate are not limited to a combination of the above-described exemplary embodiments. For instance, either one of ¼ wave plate and the ½ wave plate may be omitted within such a range as to separate the polarizations of the left-eye image and the right-eye image. Additionally, other optical parts may be added to the ¼ wave plate and the ½ wave plate.

As described above, in the present invention, spatiotemporally divided images for each viewer are displayed on the display panel, the images are separated for each viewer in the multi view mode through the active polarization glasses, and the left-eye image and the right-eye image are separated in the 3D mode. In the present invention, accordingly, there is no deterioration of aperture ratio and luminance caused by the conventional barrier, the problems of additional processes can be solved, and it is possible to realize general 2D images, different images that each viewer can individually view in the multi view mode, and stereoscopic images in the 3D mode.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A multi view and stereoscopic image display comprising:
a display panel that displays a first image for a first viewer and a second image for a second viewer in multi view mode and displays images of the left-eye and right-eye in 3D mode;
first glasses that comprise a first left-eye filter and a first right-eye filter, allow only the first image to pass through the first left-eye filter and the first right-eye filter in the multi view mode, and allow the left-eye image and the right-eye image to respectively pass through the first left-eye filter and the first right-eye filter in the 3D mode; and
second glasses that comprise a second left-eye filter and a second right-eye filter, allow only the second image to pass through the second left-eye filter and the second right-eye filter in the multi view mode, and allow the left-eye image and the right-eye image to respectively pass through the second left-eye filter and the second right-eye filter in the 3D mode.

2. The multi view and stereoscopic image display of claim 1, wherein, in the multi view mode, the display panel displays data of the first image in all pixels during an n-th frame period (n is a natural number) and data of the second image in all pixels during an (n+1)-th frame period, and
in the 3D mode, the display panel displays data of the left-eye image in all pixels during the n-th frame period and data of the right-eye image in all pixels during the (n+1)-th frame period.

3. The multi view and stereoscopic image display of claim 2, wherein, in the multi view mode, the first left-eye filter and the first right-eye filter are electrically controlled to transmit light of the first image during the n-th frame period and block light of the second image during the (n+1)-th frame period, and
the second left-eye filter and the second right-eye filter are electrically controlled to transmit light of the first image during the n-th frame period and block light of the second image during the (n+1)-th frame period.

4. The multi view and stereoscopic image display of claim 2, wherein, in the 3D mode, the first and second left-eye filters are electrically controlled to transmit light of the left-eye image during the n-th frame period and block light of the right-eye image during the (n+1)-th frame period, and
the first and second left-eye filters are electrically controlled to block light of the left-eye image during the n-th frame period and transmit light of the right-eye image during the (n+1)-th frame period.

5. The multi view and stereoscopic image display of claim 1, wherein the display panel displays data of the first image in odd-numbered lines and data of the second image in even-numbered lines in the multi view mode, and
in the 3D mode, the display panel displays data of the left-eye image is on the odd-numbered lines and data of the right-eye image on the even-numbered lines.

6. The multi view and stereoscopic image display of claim 5, further comprising a pattern retarder that is bonded onto the display panel to convert the light incident from the odd-numbered lines of the display panel and convert the light incident from the even-numbered lines of the display panel.

7. The multi view and stereoscopic image display of claim 5, wherein each of the left-eye and right-eye filters of the active polarization glasses comprises a ¼ wave plate, a polarization switching cell electrically controlled to let the light having passed through the ¼ wave plate pass or delay the phase of the light having passed through the ¼ wave plate by ½ wave length, and a polarization plate for transmitting only a specific linearly polarized light out of the light having passed through the polarization switching cell.

8. The multi view and stereoscopic image display of claim 7, wherein, in the multi view mode, only the light of the first polarization passes through the first left-eye filter and the first right-eye filter, and only the light of the second polarization passes through the second left-eye filter and the second right-eye filter, and
in the 3D mode, only the light of the first polarization passes through the first and second left-eye filters, and only the light of the second polarization passes through the first and second left-eye filters.

9. The multi view and stereoscopic image display of claim 8, wherein the polarization switching cell formed at the first left-eye filter delays the phase of the light having passed through the ¼ wave plate by ½ wavelength, and the polarization switching cell formed at the first right-eye filter allows the light having passed through the ¼ wave plate to pass therethrough, and
the polarization switching cell formed at the second left-eye filter allows the light having passed through the ¼ wave plate to pass therethrough, and delays the phase of the light having passed through the ¼ wave plate by ½ wavelength.

10. The multi view and stereoscopic image display of claim 8, wherein, in the 3D mode, the polarization switching cells formed at the left-eye filters and right-eye filters of the first and second glasses delay the phase of the light having passed through the ¼ wave plate by ½ wavelength.

11. The multi view and stereoscopic image display of claim 2, further comprising an active retarder that is bonded onto the display panel to convert the light incident from the display panel into first polarized light during the n-th frame period and convert the light incident from the display panel into second polarized light during the (n+1)-th frame period.

12. The multi view and stereoscopic image display of claim 11, wherein each of the left-eye and right-eye filters of the active polarization glasses comprises a ¼ wave plate, a polarization switching cell electrically controlled to let the light having passed through the ¼ wave plate pass or delay the phase of the light having passed through the ¼ wave plate by ½ wave length, and a polarization plate for transmitting only a specific linearly polarized light out of the light having passed through the polarization switching cell.

13. The multi view and stereoscopic image display of claim 12, wherein, in the multi view mode, only the light of the first polarization passes through the first left-eye filter and the first right-eye filter, and only the light of the second polarization passes through the second left-eye filter and the second right-eye filter, and
in the 3D mode, only the light of the first polarization passes through the first and second left-eye filters, and only the light of the second polarization passes through the first and second left-eye filters.

14. The multi view and stereoscopic image display of claim 13, wherein the polarization switching cell formed at the first left-eye filter delays the phase of the light having passed through the ¼ wave plate by ½ wavelength, and the polarization switching cell formed at the first right-eye filter allows the light having passed through the ¼ wave plate to pass therethrough, and
the polarization switching cell formed at the second left-eye filter allows the light having passed through the ¼ wave plate to pass therethrough, and delays the phase of the light having passed through the ¼ wave plate by ½ wavelength.

15. The multi view and stereoscopic image display of claim 13, wherein, in the 3D mode, the polarization switching cells formed at the first left-eye filter, the first right-eye filter, the second left-eye filter, and the second right-eye filter are the second right-eye filter delay the phase of the light having passed through the ¼ wave plate by ½ wavelength.

16. The multi view and stereoscopic image display of claim 1, further comprising:
a short-range communication transmitting unit that transmits first audio information synchronized with the first image and second audio information synchronized with the second image through a short-range communication channel;
a first short-range communication receiving unit that is installed at the first glasses and receives the first audio information through the short-range communication channel;
a first speaker that is installed at the first glasses and reproduce the audio information received through the first short-range communication receiving unit;
a second short-range communication receiving unit that is installed at the second glasses and receives the second audio information through the short-range communication channel; and
a second speaker that is installed at the second glasses and reproduces the second audio information received through the second short-range communication receiving unit.
